(19) United States
(12) Patent Application Publication
(10) Pub. No.: US 2025/0209232 A1
(43) Pub. Date: Jun. 26, 2025

(54) SYSTEM AND METHOD FOR DETERMING WASTEWATER PLUMBING DESIGN AND INSTALLATION IN A MULTI-STOREY BUILDING

(71) Applicant: PipePax Pty Ltd, Beard (AU)

(72) Inventors: Nathan Lenarduzzi, Beard (AU); Robert Pantano, Beard (AU); Joshua Pirotta, Beard (AU)

(21) Appl. No.: 19/078,244

(22) Filed: Mar. 12, 2025

Related U.S. Application Data
(63) Continuation of application No. PCT/AU2023/050887, filed on Sep. 14, 2023.

(30) Foreign Application Priority Data
Sep. 15, 2022 (AU) 2022902672

(51) Int. Cl. G06F 30/18; G06F 113/14

(52) U.S. Cl. CPC G06F 30/18; G06F 2113/14

(57) ABSTRACT

A method for arranging pipework is described including receiving dimensions of a wet area and penetrations associated with the wet area, and determining a pipework layout based on the penetrations associated with the wet area. Locations are determined for a first set of anchor points to support at least a section of the pipework layout, and locations are also determined for a second set of anchor points to support at least the section of the pipework layout. The method further includes producing a template identifying the determined locations of the first and second set of anchor points, and using the template, to affix anchors to the wet area at the identified locations of the first and second anchor points. Anchoring units are attached to support a length of pipe and at least one coupling unit.

### TECHNICAL FIELD

This disclosure relates to locating wastewater plumbing fittings and fixings, and arranging pipework for multi-storey residential buildings.

### BACKGROUND

Multi-storey residential buildings generally have common floor plan designs across the multiple levels of the structure. For example, the floor plan design of a number of apartments or dwellings on one level of the structure will be repeated on subsequent levels. Minor differences, such as mirroring floor plan designs, may also be employed to utilise the overall footprint of the building.

Following on from the above, wastewater plumbing design for wet areas (such as bathrooms and laundries) will also be common for a number of apartments or dwellings on the same level of the building, and be repeated across multiple levels of the structure.

The fittings and fixings used to support wastewater plumbing pipework in multi-storey buildings (such as clips, threads, pipe shoes, clamps, anchors etc.) can be installed after the concrete flooring is poured and cured by drilling into the underside of the concrete flooring at suitable locations to insert the fixing and subsequent fitting. This requires a human operator to interpret the wastewater plumbing design and determining where to drill into the concrete flooring at each wet area location in the building to place the fixings. While the operator may become familiar with common designs for numerous wet areas in the building and know where each fixing should be drilled, the position will be slightly different at each location. This affects the consistency in pipe length when securing piping to the fittings. That is, a length of pipe will be slightly longer or shorter in one particular section of one wet area when compared to a similar/identical wet area at another location in the building. Additionally, drilling into concrete flooring can possibly affect structural integrity of the concrete, as well as generating silica dust.

Alternatively, fixings can be placed in the relevant position prior to the pouring of concrete flooring. Relevant positions can be determined by surveying equipment utilizing GPS or radio for example, with complimentary software. Once the concrete is poured, the fixing is encased with endpoints exposed to eventually receive the relevant fitting. This process is repeated for each wet area design on a single floor of a building, and subsequently repeated on each floor of the structure. The process over a large number of floors is labor-intensive and time consuming.

Accordingly, there is a need for a more efficient methodology for the implementation of fixings and fittings into concrete flooring of multi-storey residential buildings to support pipework layouts.

### SUMMARY

In general, this document describes a system and method for efficiently identifying fixing or anchor points for a wet area in a multi-storey building to support wastewater pipework. Various aspects can include some, all, or none of the following features.

In a first aspect, there is described a method for arranging pipework, including receiving dimensions of a wet area and penetrations associated with the wet area, and determining a pipework layout based on the penetrations associated with the wet area. Locations are determined for a first set of anchor points to support at least a section of the pipework layout, and locations are also determined for a second set of anchor points to support at least the section of the pipework layout. The method further includes producing a template identifying the determined locations of the first and second set of anchor points, and using the template, to affix anchors to the wet area at the identified locations of the first and second anchor points. An anchoring unit is attached to each anchor at the identified locations of the first and second anchor points, and a length of pipe and at least one coupling unit is attached to the anchoring units attached to a first anchor relating to the first set of anchor points and a second anchor relating to the first set of anchor points, and to at least one anchoring unit attached to at least one anchor relating to the second set of anchor points located between the first and second anchors relating to the first set of anchor points.

In a further aspect, the locations for the first set of anchor points are determined based on the length of pipe and the at least one coupling unit required at the section of the pipework layout, and the locations for the second set of anchor points are determined based on a required fall gradient of the length of pipe and the at least one coupling unit required at the section of the pipework layout.

In an additional aspect, there is described a system for arranging pipework, including a template identifying locations of a first and second set of anchor points for positioning anchors in concrete formwork relating to a wet area, wherein the first set of anchor points are identified based on a length of pipework and at least one coupling unit, and the second set of anchor points are identified based on a required fall gradient of the length of pipework and the at least one coupling unit. The system further includes a plurality of anchoring units, with each anchoring unit attached to each of the positioned anchors relating to the locations of the first and second set of anchor points, wherein the length of pipework and at least one coupling unit are attached to a first anchoring unit attached to a first positioned anchor relating to the location of the first set of anchor points and a second anchoring unit attached to a second positioned anchor relating to the location of the first set of anchor points, and to a third anchoring unit attached to a positioned anchor relating to the location of the second set of anchor points located between the first and second positioned anchors from the first set of anchor points.

In another aspect, the template is based on at least a portion of the wet area dimensions, and the template is made of acrylic or composite plastics, plywood or reinforced cardboard, utilising recycled materials where appropriate.

In another aspect, the anchors include a threaded recess, and the anchoring unit includes a length of threaded rod that can affix to the threaded recess of the anchors. The length of the threaded rod is determined based on the required gradient of the length of pipe and the at least one coupling unit required at the section of the pipework layout. Further, the anchoring unit attached to the first anchor relating to the first set of anchor points is attached to the length of pipe, and the anchoring unit attached to the second anchor relating to the first set of anchor points is attached to the at least one coupling unit.

In another aspect, the anchoring unit includes a securing unit to attach to the length of pipe and/or the at least one coupling unit. The securing unit is a clip or clamp.

In another aspect, the length of pipe is determined based on locations of the first and second set of anchor points. Further, the pipework is constructed of acoustic pipes.

In a further aspect, there is described a method for determining a length of pipework, including determining locations for a first set of anchor points to affix at least one securing unit to support a length of pipe, and determining locations for a second set of anchor points to affix at least one securing unit and support the length of pipe. The length of the pipe is determined by the distance between a first anchor point in the first set of anchor points and a second anchor point in the first set of anchor points, and wherein the length of pipe traverses the first and second anchor points in the first set of anchor points, and at least one anchor point in the second set of anchor points.

The methods, systems, and techniques described herein may provide one or more of the following advantages. First, the present methodology reduces the time it takes to position the fixings (anchors) in place prior to the pour of the concrete flooring. Further, anchors are placed in identical corresponding positions across multiple wet areas, and across multiple floors of the building structure. This allows piping and supporting materials to be cut and/or prepared to accurate lengths on a large scale off-site, given the commonality of the piping requirements across multiple wet areas and the exact placing of common anchors in the multiple wet areas, avoiding the need to cut individual lengths of piping based on inconsistent anchor positions according to prior art techniques. The commonality of the piping requirements also reduces wastage in cuts of piping and supporting materials such as threaded rods that attach to the positioned anchors. Additionally, given there is no drilling into concrete, the presence of silica dust is avoided.

The details of one or more implementations are set forth in the accompanying drawings and the description below. Other features and advantages will be apparent from the description and drawings, and from the claims.

### DESCRIPTION OF DRAWINGS

FIG. 1 is an example wet area design for wastewater pipework layout in a dwelling.

FIG. 2 is an example template constructed in accordance with an embodiment of the present invention.

FIG. 3 is a further example wet area design for wastewater pipework in a dwelling.

### DETAILED DESCRIPTION

Multi-storey building design and construction presents many challenges for efficient plumbing systems. These include drainage, water pressure, water temperature, fire sprinkler services, and wastewater management. This disclosure describes the implementation of an efficient fixing position identification system for wastewater plumbing fittings for multi-storey residential buildings.

Wastewater refers to the water expelled from bathtubs, showers, toilets, washing machines and the like after use. Wastewater plumbing pipework, such as piping and their supporting structures, are generally located in the immediate spacing below the flooring of the respective wet area. A general wastewater pipe, such as a sanitary or sewerage drainage line, forms a common point for wastewater to flow and eventually be expelled from the building plumbing system. Each wastewater unit, such as a toilet or bathtub, has dedicated pipework to allow the wastewater to flow to the general wastewater pipe. For example, when a bathtub is emptied, the water drains from the bathtub's lowest point and flows through pipework that is connected to the general wastewater pipe, which then flows out of the building's plumbing system to the sewer. The pipework from the bathtub to the general wastewater pipe may include several pipe fittings, including “S” traps, elbow joins and junctions, to allow the wastewater to flow freely.

It will be appreciated that the pipework and piping requirements must include a fall gradient to ensure a gravity assisted flow of the wastewater.

The pipework is subject to constant movement by the wastewater. Accordingly, the pipework and associated fittings must be secured to reduce the physical movement, which over time, can reduce the effectiveness of pipework connection and may lead to pipework leaking.

In a concrete flooring system that is commonly used in multi-storey residential buildings, pipework can be secured to the underside of the flooring adjacent the wet area of a dwelling. Pipework can be secured by affixing a suitable fitting, such as a clip or clamp, to the underside of the concrete adjacent the wet area and securing or clamping a suitable length of pipe. Traditionally, positioning of the fitting was done by the pipework installer, such as a plumber, and judged or determined based on such factors as ease of access, length of available pipe and positioning of other components such as elbow and wye joins. The fitting would then be secured by drilling into the underside of the concrete and affixing the fitting using plugs, expansion anchors and the like.

Silicon dioxide (or silica) is a naturally occurring mineral found in some stones, rocks, sand, gravel and clay. Silica dust may occur when bricks, pavers, tiles and concrete is cut, crushed, drilled or sanded (honed). Inhaling crystalline silica can lead to serious, sometimes fatal illnesses including silicosis, lung cancer, tuberculosis (in those with silicosis), and chronic obstructive pulmonary disease (COPD). It is therefore desirable to avoid concrete drilling.

Embodiments of the present invention utilise an anchoring system made up of individual anchors that are placed in position and cast into concrete when poured. The position of each individual anchor is determined by analysing the dimensions and layout of the wet area and creating a suitable pipework path from each wastewater unit, such as a toilet or vanity basin, to the general wastewater pipe. A first set of anchor position points are determined based on the length of pipe and join locations of the pipework. An anchor point need not be exactly where the pipe is connected to another fitting, such as another piece of pipe or elbow join, but in a vicinity to adequately support the pipework at the junction, such as up to 50 mm to 300 mm (or longer) from the join along the pipe.

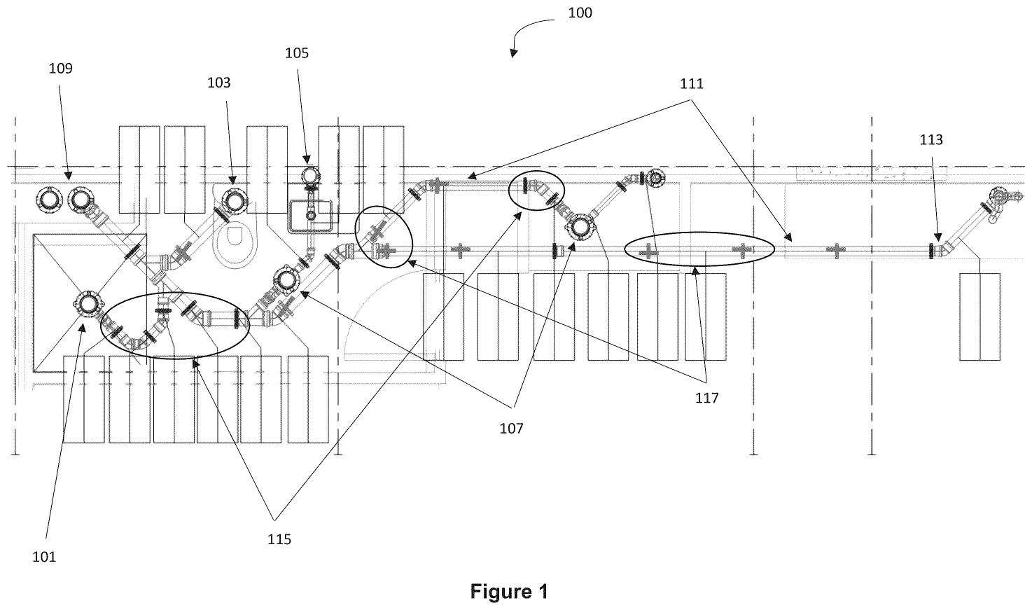

FIG. 1 shows an example wet area pipework layout design 100 for a bathroom and laundry in a dwelling on a floor of a multi-storey residential building. A wet area may be a bathroom and/or a laundry, but may also include water closets, powder rooms, wet rooms etc. The wet area in FIG. 1 shows a bathroom unit that includes a shower with a shower waste 101, a toilet with a toilet waste 103, a vanity basin with a basin waste 105, and a number of floor wastes 107. Each of the wastes 101, 103, 105, and 107 of the wet area generally requires a penetration in the flooring and leads to a general wastewater pipe 109 by the pipework layout. Penetrations occur when piping passes from one side of the floor of the wet area to another (generally the top side to the underside) to allow fluid flow and remove pipework from sight in the dwelling. For example, a penetration is required at the toilet waste 103 to allow fluid to flow from the toilet to the general wastewater pipe 109 that is located under the flooring. The general wastewater pipe 109 may be connected to other general wastewater pipes on the same or other floors of the multi-storey residential building that expel wastewater from the building.

The pipework layout includes sections of numerous piping and respective couplings used to facilitate fluid flow to an end point, such as from the toilet waste 103 to the general wastewater pipe 109. As an example, the section of piping 111 is shown connected to a coupling 113 as an elbow join, but may include other coupling or connectors as shown in the figure to form sections of the pipework layout. A section of the pipework layout may include a number of piping and coupling parts, or may include a single pipe and respective coupling part, or may refer to all of the pipework in the wet area.

In order to provide support for sections of the piping and couplings in the pipework layout on the underside of the concrete flooring, locations of a first set of anchor points 115 are determined. The locations of the first set of anchor points 115 are generally determined proximate a join or coupling of piping to provide integrity to the strength of the coupling unit so as to avoid movement under fluid flow load and pressure. The length of the required piping is also considered when determining locations of the first set of anchor points. It will be appreciated that not all of the locations of the first set of anchoring positions are identified by reference numerals in FIG. 1; however each of the locations of the first anchor points or positions can be identified by a darkened line in the figure and their proximity to a pipe coupling or join.

The pipework layout and first set of anchoring positions 115 can be determined using architecture, engineering and construction infrastructure modelling software, such as Revit®.

To further support sections of the pipework layout, and to assist with efficient installation of the pipework materials, locations of a second set of anchor points 117 are determined. The locations of the second set of anchor points 117 are calculated based on the length of the pipework layout and corresponding required fall gradient. The locations of the second set of anchor points 117 allows for additional anchoring units to advantageously add support to the relevant section of the pipework when secured to the piping and concrete flooring, in addition to anchoring units relating to the first set of anchor points 115. The additional anchoring units relating to the location of the second set of anchor points 117 also assist in the efficient installation of pipework with correct fall gradient across the length of the piping. It will be appreciated that not all of the locations of the second set of anchor points are identified by reference numerals in FIG. 1; however each of the locations of the second anchor positions or points can be identified by a darkened cross line in the figure (examples shown at figure reference 117). It will be further appreciated that not all of the locations of the second set of anchor points are identified in FIG. 1, and that additional anchor points from the determined locations of the second set of anchor points could be included to cater for support of the pipework as well as the required fall gradient. For example, additional anchor points relating to the locations of the second set of anchoring positions could be included to cater for pipework support from the shower waste 101 to the general wastewater pipe 109 as shown in FIG. 1.

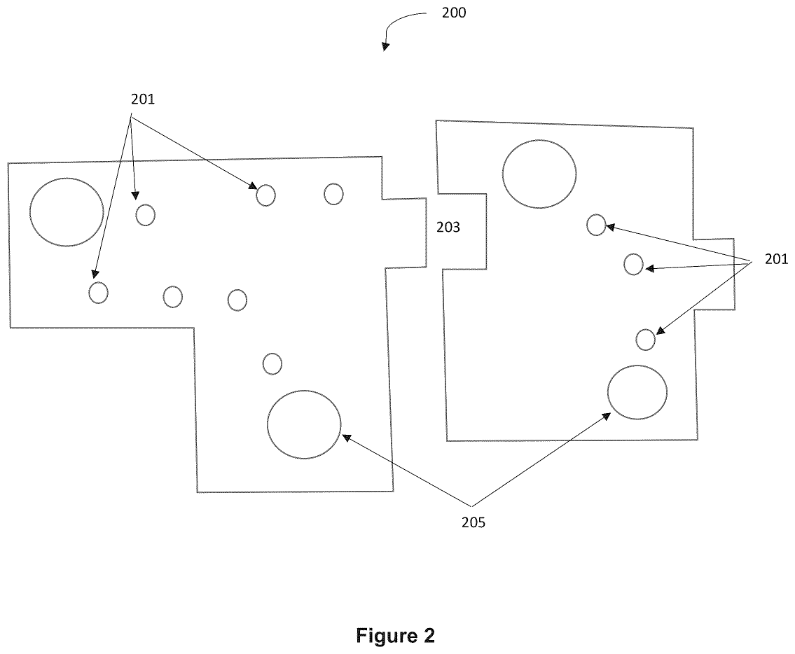

Once the locations of the first set of anchor points 115 and the locations of the second set of anchor points 117 are determined, a flooring template can be constructed. An example flooring template 200 is shown in FIG. 2, where each of the locations of the first and second set of anchor points are identified for the wet area of the dwelling in the residential building. This example template 200 does not correspond to the wet area design layout shown in FIG. 1. Each anchor point location 201 of the first and second anchor points may be identified on the template by a protrusion or hole marking. Once constructed, the template may be transported on-site and calibrated using a reference point, such as the pipe penetration for the general wastewater pipe, or other fitted piping penetration 205 such as a shower waste or toilet waste, or physical structure such as a wall. The reference point could also be determined by surveying equipment. When the template is laid on the flooring area (such as the wooden formwork) of the wet area according to the reference point, locations of the anchor points 201 can be easily identified by the hole markings, and individual anchors can be placed at the exact locations corresponding to the determined locations of the first and second set of anchor points. Once the individual anchors are in place, the template can be removed, and the concrete can be poured.

The individual anchors may be the same at each determined location of anchor points, or may be different depending on the piece of pipework to be supported, its weight, or the hanging length of the fitting used for support. Therefore, the identified locations of the anchor points 201 may be different sizes to accommodate different anchors; however, it will be appreciated that all the identified locations of the anchor points 201 may be the same size to accommodate common anchors and contribute to the efficient installation of the pipework materials. A “cast-in” anchoring system with a single or multiple internal thread is preferred for the anchors that can be easily laid on wood formwork (or affixed in other known manners) and exposed when the formwork is removed after the concrete is poured and cured.

The flooring template 200 may be constructed of any suitable material that is lightweight to be able to be easily transported to, and moved on, the building site. The material should also be of suitable strength to be used multiple times without wearing (or minimal wearing). Example material for manufacture of the template includes acrylic plastics or composite plastics (such as Perspex®), plywood or reinforced cardboard, utilising recycled materials where appropriate.

The template 200 may be constructed to cover the entire floor area of the proposed wet area of the dwelling in the building. This allows for ease of installation of the anchors across multiple dwellings for identically designed wet areas. Alternatively, the flooring template may be constructed to cover a portion of the formwork floor area of the proposed wet area. This improves the ability of the template to be transported, and once on-site, can be laid on the formwork floor according to the wet area design pipework layout. Portions of the flooring template can connect together by butting or fitting at complimentary shaped male/female locations 203 on the template, in a similar manner to a jigsaw. It will be appreciated that common portions of wet areas could use one particular template, and then connect together with an alternative template to accommodate a variation in pipework layout, where small variations may exist between wet area design layouts of particular dwellings. For example, a wet area design layout of one particular dwelling may have a secondary vanity basin and require an additional basin waste.

Further, different portions of the flooring template 200 can be used on different wet areas for different dwellings. For example, where a number of dwellings in the residential building have a common configuration of a toilet and vanity basin, but the position of the shower and floor waste drain varies for the different dwellings, a portion of the flooring template can be constructed based on the locations of the toilet waste and the basin vanity waste, whereas a different portion of the template can be constructed based on the locations of the shower waste and floor wastes. In this way, certain portions of flooring templates 200 can be designed and reused across the entire residential building site, which saves production materials and reduces waste, resulting in a positive effect on the environment.

When the concrete has been poured on the particular floor of the residential building, the anchors will have been encased and secured in the concrete floor. Once the concrete has been cured, and the formwork removed, the individual anchor will be revealed on the underside of the concrete flooring. This will expose the fixings of the anchor, such as a threaded recess.

Hanging rods are threaded steel rods that can attach at one end to a securing unit such as a clip or clamp to attach to a length of pipe and/or the at least one coupling unit. The opposite end of the hanging rod can affix to the exposed anchor in the concrete flooring via the threaded recess of each anchor.

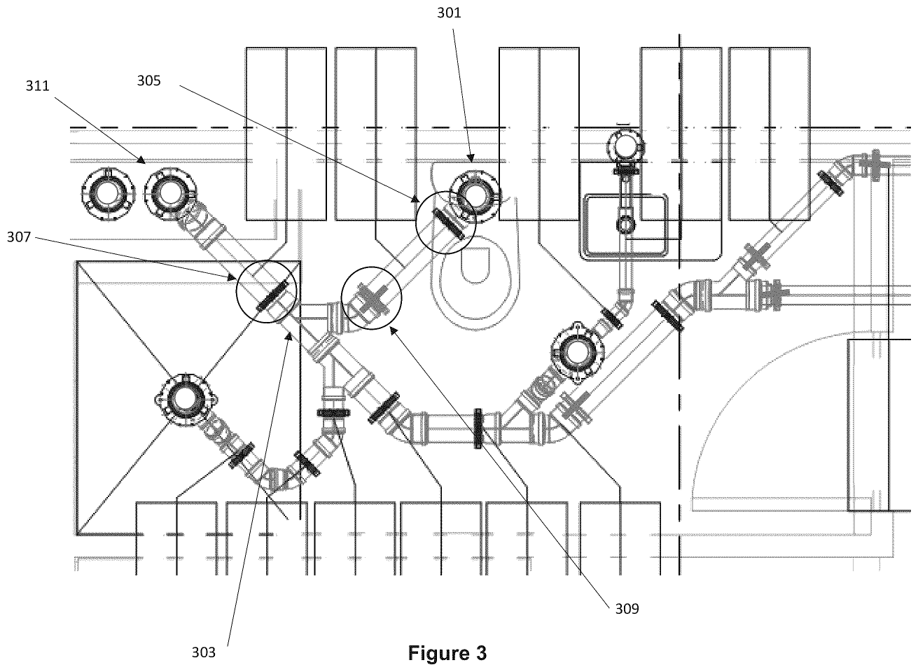

The length of each threaded rod is calculated to allow for the required fall gradient of the piping over the length of the pipe. The length of pipe may include the relevant coupling unit as required at the section of the pipework layout, or may only include the length of the actual pipe.

Where a section of the pipework requires a fall gradient of 1.65% to 2% for example, the length of the threaded rods to attach to the anchors in the concrete flooring relating to the particular length of piping will be sequentially longer to accommodate for the fall gradient when the pipe is secured to the securing unit attached to the threaded rod. The fall gradient for a particular length of pipe, which may or may not include at least one coupling unit, is difficult to determine using just anchors relating to locations of the first set of anchor points. This is because the locations of the first set of anchor points may relate to a location or join at an end of the pipe and at the coupling unit attached to the other end of the pipe. An example of this configuration is shown in FIG. 3, where the length of pipe used to connect the toilet waste 301 to the general wastewater pipe 311 includes a location of an anchor point 305 relating to the first set of anchor points at a location proximate the join at the toilet waste 301, and another location of an anchor point 307 relating to the first set of anchor points at a location beyond the elbow join coupling unit and wye coupling fitting 303. Gradient control across these pieces of pipework (the pipe, the elbow coupling unit and the wye coupling fitting) relies on the human operator to adjust the length of threaded rod attached to the securing unit attached at both anchor locations 305 and 307. The fall gradient of the remaining pipework in the pipework layout also needs to be taken into account. This results in prior art techniques of cutting the threaded rod on-site to adjust the fall gradient across the two anchor locations 305 and 307, as well as other threaded rods relating to other pipework. The inclusion of the anchor located at 309 from the second set of anchor points provides an additional point of reference to accurately determine the fall gradient for the relevant section of the pipework layout. That is, the fall gradient is determined through three points 305, 309, and 307, allowing for accurate length calculation of the threaded rods without adjustment on-site.

Where wet area floor designs of a number of dwellings have common pipework requirements, the lengths of the threaded rods across the dwellings attached to anchor point locations relating to the first and second set of anchor points will also be common. This consistency allows for the preparation of the threaded rods to be conducted off-site on a large scale. For example, a large length of steel threaded rod can be cut to exact lengths as required to accommodate for the fall gradient at relevant sections of the pipework layout in the wet area of the dwelling, as described above. The threaded rods can then be fully inserted into the threaded recess of the anchor, without the need for an operator to alter the length of insertion of the threaded rod for tolerance in effectively creating the fall gradient. Where this can be replicated across many wet areas in the residential building, efficiencies are gained in material production, as well as installation, and waste is reduced.

Polypropylene or polyvinyl chloride (PVC) or High Density Poly Ethylene (HDPE) pipes are commonly used in plumbing pipework. The material is lightweight with suitable strength to maintain integrity and shape for many years. It will be appreciated that while PVC or HDPE piping may be used in accordance with the current invention, any other similar plastic composite pipework system can be employed. Piping is generally cut into transportable lengths and moved to site where they are cut to service the required length for an individual wet area layout. Given the common location of the first set of anchor points in multiple dwellings of a residential building site according to the current invention, common pipe lengths can be determined. For example, and referring to FIG. 3, assuming that the presented wet area layout for a dwelling is common with a number of other wet area layouts for other dwellings in the residential building site (for example, the design is repeated across numerous dwellings on a single floor, and then repeated on multiple floors), the length of pipe required from the toilet waste 301 to the elbow join attached to the wye fitting 303 will be same for each of the numerous dwellings.

Pipe lengths can be determined by the distance between the location of a first anchor point 305 in the first set of anchor points and the location of a second anchor point 307 in the first set of anchor points. For example, the length of the pipe required for expelling wastewater from the toilet waste 301 is determined by calculating the piping distance between the location of the anchor point 305 located proximate the toilet waste and the location of the anchor point 307 down-flow from the wye fitting 303. The physical properties of the wye fitting 303 are taken into consideration when determining the piping distance between the two anchor point locations 305 and 307 in the first set of anchor points. The physical properties of other fittings, such as elbow joins, are taken into consideration when determining the piping distance between two anchor points relating to the first set of anchor points.

In the above example, the length of piping from the toilet waste 301 traverses a location of an anchor point 309 in the second set of anchor points before joining the elbow coupling unit and wye fitting 303. The anchoring unit attached to the anchor at the location of the anchor point 309 from the second set of anchor points provides stabilising support of the join of the pipe to the elbow coupling unit and wye fitting 303, and also allows accurate control of the fall gradient from the toilet waste 301 to the wye fitting 303 as described above. Accordingly, the length of the pipe can be determined by calculating the piping distance (which includes the length of pipe and any coupling units) between a location of a first anchor point 305 in the first set of anchor points and a location of a second anchor point 307 in the first set of anchor points.

Determining the lengths of pipe in the manner outlined above with respect to the distance between a location of a first anchor point 305 in the first set of anchor points and a location of a second anchor point 307 in the first set of anchor points, again allows for commonality between wet areas in numerous dwellings in the building. Where pipe lengths can be determined prior to delivery of the piping product on-site, efficiencies can be gained in the use of materials that minimise wastage. That is, individual cuts of piping on-site based on anchor point installation methods of the prior art can be avoided.

Acoustic drainage and piping is preferred in modern multi-storey residential buildings. Acoustic piping suppresses internal noise pollution that is present in PVC or other similar plastic composite pipes, caused by such things as running water and vibrations, by containing the sound within the waste and drainage pipes. Given these advantageous qualities, acoustic pipes are generally more expensive when compared to traditional PVC pipes. Accordingly, determining lengths of piping in accordance with the methodology described above, particularly suits the use of acoustic drainage where wastage is to be minimised.

The off-site preparation of plumbing materials such as piping and threaded rods allows for all of the pipework to be prepared away from the building site. This enhances the work space on-site by reducing noise and avoids cluttering that can lead to safety issues. Further, all of the pipework materials for a particular wet area layout in the multi-storey building can be packaged and delivered on-site. That is, all of the pipework material required for the wet area layout shown in FIG. 3 for example, including the piping, elbow joins, wye joins, threaded rods and securing units such as a clips or clamps, can be packaged together (for example, in a cardboard box) and delivered on-site. Each package of pipework can then be unpacked at the relevant wet area location and installed by the operator. This process can be repeated at each wet area in the multi-storey residential building once the anchors are positioned, resulting in enhancements in efficiencies in installation of the pipework.

It will be appreciated that aspects of the current invention need not be limited to multi-storey residential buildings, but could also encompass any wet area to cater for wastewater, such as in a house, hotel or office building.

Although a few implementations have been described in detail above, other modifications are possible. For example, the wastewater flows depicted in the figures do not require the particular order shown, or sequential order, to achieve desirable results. In addition, other steps may be provided, or steps may be eliminated, from the described flows, and other components may be added to, or removed from, the described pipework. Accordingly, other implementations are within the scope of the following claims.

What is claimed is:

1. A method for arranging pipework, comprising:
receiving dimensions of a wet area and penetrations associated with the wet area;
determining a pipework layout based on the penetrations associated with the wet area;
determining locations for a first set of anchor points to support at least a section of the pipework layout;
determining locations for a second set of anchor points to support at least the section of the pipework layout;
producing a template identifying the determined locations of the first and second set of anchor points;
using the template, affixing anchors to the wet area at the identified locations of the first and second anchor points;
attaching an anchoring unit to each anchor at the identified locations of the first and second anchor points; and
attaching a length of pipe and at least one coupling unit to the anchoring units attached to a first anchor relating to the first set of anchor points and a second anchor relating to the first set of anchor points, and to at least one anchoring unit attached to at least one anchor relating to the second set of anchor points located between the first and second anchors relating to the first set of anchor points.

2. The method of claim 1, wherein the locations for the first set of anchor points are determined based on the length of pipe and the at least one coupling unit required at the section of the pipework layout.

3. The method of claim 1, wherein the locations for the second set of anchor points are determined based on a required fall gradient of the length of pipe and the at least one coupling unit required at the section of the pipework layout.

4. The method of claim 1, wherein the template is based on at least a portion of the wet area dimensions.

5. The method of claim 1, wherein the anchors include a threaded recess.

6. The method of claim 5, wherein the anchoring unit includes a length of threaded rod that can affix to the threaded recess of the anchors.

7. The method of claim 6, wherein the length of the threaded rod is determined based on the required gradient of the length of pipe and the at least one coupling unit required at the section of the pipework layout.

8. The method of claim 1, wherein the anchoring unit attached to the first anchor relating to the first set of anchor points is attached to the length of pipe, and the anchoring unit attached to the second anchor relating to the first set of anchor points is attached to the at least one coupling unit.

9. The method of claim 1, wherein the anchoring unit includes a securing unit to attach to the length of pipe and/or the at least one coupling unit.

10. The method of claim 9, wherein the securing unit is a clip or clamp.

11. The method of claim 1, wherein the length of pipe is determined based on locations of the first and second set of anchor points.

12. The method of claim 1, wherein the pipework is constructed of PVC or HDPE or acoustic pipes.

13. The method of claim 1, wherein the template is made of acrylic or composite plastics, plywood or reinforced cardboard.

14. A system for arranging pipework, comprising:
a template identifying locations of a first and second set of anchor points for positioning anchors in concrete formwork relating to a wet area, wherein the first set of anchor points are identified based on a length of pipework and at least one coupling unit, and the second set of anchor points are identified based on a required fall gradient of the length of pipework and the at least one coupling unit;
a plurality of anchoring units, each anchoring unit attached to each of the positioned anchors relating to the first and second set of anchor points, wherein the length of pipework and at least one coupling unit are attached to a first anchoring unit attached to a first positioned anchor relating to the first set of anchor points and a second anchoring unit attached to a second positioned anchor relating to the first set of anchor points, and to a third anchoring unit attached to a positioned anchor relating to the second set of anchor points located between the first and second positioned anchors from the first set of anchor points.

15. The system of claim 14, wherein the positioned anchors include a threaded recess.

16. The system of claim 15, wherein the anchoring unit includes a length of threaded rod that can affix to the threaded recess of the positioned anchors.

17. The system of claim 16, wherein the length of the threaded rod is determined based on the required gradient of the length of pipe and the at least one coupling unit.

18. The system of claim 14, wherein the first anchoring unit attached to the first positioned anchor relating to the first set of anchor points is attached to the length of pipe, and the second anchoring unit attached to the second anchor relating to the first set of anchor points is attached to the at least one coupling unit.

19. The system of claim 18, wherein the first and second anchoring units include a securing unit to attach to the length of pipe and the at least one coupling unit.

20. The system of claim 14, wherein the template is made of acrylic or composite plastics, plywood or reinforced cardboard.
